(19) United States
(12) Patent Application Publication
(10) Pub. No.: US 2008/0024702 A1
(43) Pub. Date: Jan. 31, 2008

(54) PIXEL STRUCTURE AND FABRICATION METHOD THEREOF

(75) Inventors: Fu-Yuan Shiau, Chiayi City (TW); June-Ming Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/460,257

(22) Filed: Jul. 27, 2006

(51) Int. Cl. G02F 1/1335

(52) U.S. Cl. 349/114

(57) ABSTRACT

A pixel structure and a fabricating method thereof are provided. The method includes providing a substrate; forming a gate and a gate insulating layer on the substrate, wherein the gate insulating layer covers the gate; forming a semiconductor layer and a conductor layer over the substrate; providing a half tone mask (HTM); forming a patterned photoresist layer on the conductor layer by using the HTM; removing portions of the conductor layer and the semiconductor layer by using the patterned photoresist layer as a mask to form a source, a drain and a channel layer; removing the patterned photoresist layer; forming a patterned passivation layer over the substrate, which has a contact opening for exposing a portion of the drain; and forming a transparent pixel electrode on the substrate, which is electrically connected to the drain via the contact opening.

### BACKGROUND OF THE INVENTION

1. Field of the Invention

The present invention relates to a pixel structure and a fabrication method thereof, and more particularly, to a pixel structure formed by using a half tone mask and a fabrication method thereof.

2. Description of Related Art

In current society, mostly due to the development of semiconductor elements and display devices, multimedia technology has become quite advanced. As far as the display is concerned, the liquid crystal display, because of its advantageous features such as high resolution, high space utilization efficiency, low power consumption, and radiation free, has gradually become the mainstream of the display market.

Generally, liquid crystal displays (LCDs) are classified into transmissive type, reflective type and transflective type according to their light source and the type of the array substrate used. The transmissive LCD mainly uses a back light as the light source. The pixel electrodes on the array substrate are transparent electrodes so that the back light can penetrate. The reflective LCD mainly uses a front light or an external light source as the light source. The pixel electrodes on the array substrate are metal electrodes or reflective electrodes made of material having good reflective property, which is suitable for reflecting the front light or the external light source. The transflective LCD may use the back light and the external light source at the same time to display, and the pixels thereon may be divided into a transmissive region and a reflective region. A transparent electrode is provided on the transmissive region so that the back light can penetrate, and a reflective electrode or reflective layer suitable for reflecting the external light source is provided on the reflective region.

FIGS. 1A˜1D show schematic views of a method of fabricating a conventional transflective pixel structure. Referring to FIG. 1A, first, a substrate 100 is provided. Next, a thin film transistor 110 is formed on the substrate 100. The thin film transistor 110 is a bottom gate structure. Particularly, the thin film transistor 110 includes a gate 110g, a source 110s, a drain 110d, a gate insulating layer 110i and a channel layer 110c. It should be noted that each of the gate 110g, the channel layer 110c, the source 110s and the drain 110d need to be defined by one lithography process and one etching process. In other words, three lithography processes and three etching processes are generally required to form the thin film transistor 110.

Referring to FIG. 1B, a patterned passivation layer 120a is formed over the substrate 100 to cover the thin film transistor 110. Particularly, the steps of forming the patterned passivation layer 120a include depositing a passivation layer material over the substrate 100, and then patterning the passivation layer material using a lithography process and an etching process to form the patterned passivation layer 120a. As shown in FIG. 1B, the patterned passivation layer 120a has a contact opening 10 which exposes the drain 110d of the thin film transistor 110. Further, the patterned passivation layer 120a may be divided into a reflective region R and a transmissive region T. A reflective pixel electrode comprised of reflective material is coated on the reflective region R. In order to make the light reflected from the surface of the reflective region R more uniformly, a successive concave-convex surface is formed on the patterned passivation layer 120a in the reflective region R. The surface of the patterned passivation layer 120a in the transmissive region T is flat.

Referring to FIG. 1C, a transparent pixel electrode 130a is formed over the substrate 100. Generally, the method of fabricating the transparent pixel electrode 130a includes forming a transparent conductive material to cover the patterned passivation layer 120a and then patterning the transparent conductive material using a lithography process and an etching process to complete the fabrication of the transparent pixel electrode 130a. It should be noted that the transparent pixel electrode 130a is electrically connected to the drain 110d through the contact opening 10.

Referring to FIG. 1D, a reflective pixel electrode 140a is formed on the transparent pixel electrode 130a. Particularly, the steps of forming the reflective pixel electrode 140a include depositing a reflective layer material on the transparent pixel electrode 130a and patterning the reflective layer material using a lithography process and an etching process to form the reflective pixel electrode 140a.

Thus, the number of masks used in the above-mentioned fabricating process increases the cost of fabrication, and also, the increasing number of masks increases the time of fabrication.

### SUMMARY OF THE INVENTION

In view of this, an object of the present invention is to provide a method of fabricating a pixel structure capable of reducing the fabrication cost.

Another object of the present invention is to provide a method of fabricating a pixel structure capable of reducing the fabrication time.

Another object of the present invention is to provide a pixel structure for improving the electrical quality thereof.

Another object of the present invention is to provide a pixel structure that can be fabricated using a more simplified process and thereby reduce the fabrication cost.

In accordance with the above objects and or other objects of the present invention, a method of fabricating a pixel structure is provided, which includes providing a substrate, and sequentially forming a gate and a gate insulating layer over the substrate, wherein the gate insulating layer covers the gate; sequentially forming a semiconductor layer and a conductor layer over the substrate; providing a first half tone mask (HTM) and forming a first patterned photoresist layer on the conductor layer by using the first HTM; removing portions of the conductor layer and the semiconductor layer by using the first patterned photoresist layer as the mask to form a source, a drain and a channel layer; removing the first patterned photoresist layer; forming a patterned passivation layer over the substrate, which has a contact opening exposing a portion of the drain; and forming a transparent pixel electrode over the substrate, which is electrically connected to the drain via the contact opening.

In an embodiment of the present invention, after the transparent pixel electrode is formed, the pixel structure further includes a step of forming a reflective pixel electrode. Furthermore, the method of forming the transparent pixel electrode and the reflective pixel electrode includes sequentially forming a first pixel material and a second pixel material over the substrate; providing a second HTM and forming a second patterned photoresist layer on the second pixel material by using the second HTM; removing portions of the second pixel material and the first pixel material by using the second patterned photoresist layer as the mask to form a reflective pixel electrode and a transparent pixel electrode; and removing the second patterned photoresist layer.

In accordance with the above-mentioned objects and or other objects of the present invention, a method of fabricating a pixel structure is provided. First, a substrate is provided, and a gate and a gate insulating layer are formed over the substrate, wherein the gate insulating layer covers the gate. A channel layer is formed over the gate insulating layer above the gate. A source and a drain are formed on the channel layer. A patterned passivation layer is formed over the substrate, which has a contact opening exposing a portion of the drain. A first pixel material and a second pixel material are sequentially formed over the substrate. An HTM is provided, and a patterned photoresist layer is formed on the second pixel material by using the HTM. Portions of the second pixel material and the first pixel material are removed by using the patterned photoresist layer as a mask to form a reflective pixel electrode and a transparent pixel electrode. The transparent pixel electrode is electrically connected to the drain via the contact opening. Thereafter, the patterned photoresist layer is removed.

The present invention further provides a pixel structure including a substrate, a gate, a gate insulating layer, a channel layer, a source, a drain, a patterned passivation layer and a transparent pixel electrode. The gate is disposed on the substrate. The gate insulating layer covers the gate. The channel layer is disposed on the gate insulating layer, and located above the gate. The source and the drain are disposed on the channel layer, and the boundary of the source and the drain are within the boundary of the channel layer. The patterned passivation layer covers the source and the drain, the channel layer and the gate insulating layer. The transparent pixel electrode is disposed on the patterned passivation layer, and electrically connected to the drain.

In an embodiment of the present invention, the above-mentioned pixel structure further includes a reflective pixel electrode disposed on the transparent pixel electrode. In addition, the boundary of the reflective pixel electrode can be within the boundary of the transparent pixel electrode.

The present invention further provides a pixel structure including a substrate, a gate, a gate insulating layer, a channel layer, a source a drain, a patterned passivation layer, a transparent pixel electrode and a reflective pixel electrode. The gate is disposed on the substrate, and the gate insulating layer covers the gate. The channel layer is disposed on the gate insulating layer, and located above the gate. The source and the drain are disposed on the channel layer and the gate insulating layer. The patterned passivation layer covers the source and the drain, the channel layer and the gate insulating layer. The transparent pixel electrode is disposed on the patterned passivation layer, and electrically connected to the drain. The reflective pixel electrode is disposed on a portion of the transparent pixel electrode, and the boundary of the reflective pixel electrode is within the boundary of the transparent pixel electrode.

The present invention uses the HTM to form the patterned photoresist layer, and uses the patterned photoresist layer as the mask to perform the patterning process to simultaneously form the channel layer, the source and the drain. Therefore, one mask can be saved in the fabrication process, thus reducing the fabrication cost. In addition, in the fabrication of the pixel structure of the transflective liquid crystal display, another HTM may also be used to form another patterned photoresist layer. Next, the patterned photoresist layer may be used to simultaneously form a reflective pixel electrode and a transparent pixel electrode. Therefore, one mask can be saved, thus further reduce the fabrication cost.

In order to make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a portion of this specification. The drawings illustrate embodiments of the invention and, together with the description, serve to explain the principles of the invention.

FIGS. 1A to 1D show schematic views illustrating a method of fabricating a conventional transflective pixel structure.

FIGS. 2A to 2E are schematic views illustrating a method fabricating a pixel structure according to a first embodiment of the present invention.

FIG. 2F is a schematic view a pixel structure according to a second embodiment of the present invention.

FIGS. 2E′ to 2H′ are schematic views illustrating a method of fabricating a pixel structure according to a third embodiment of the present invention.

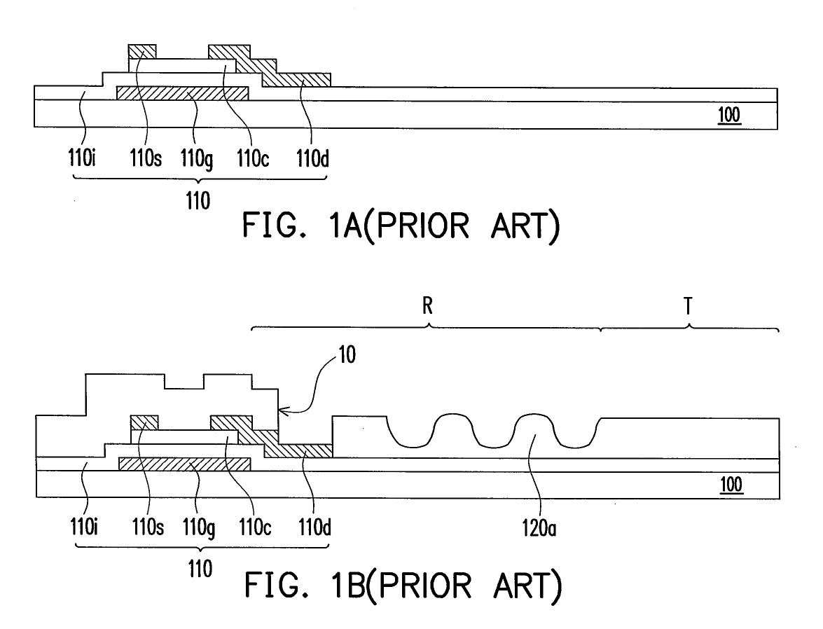

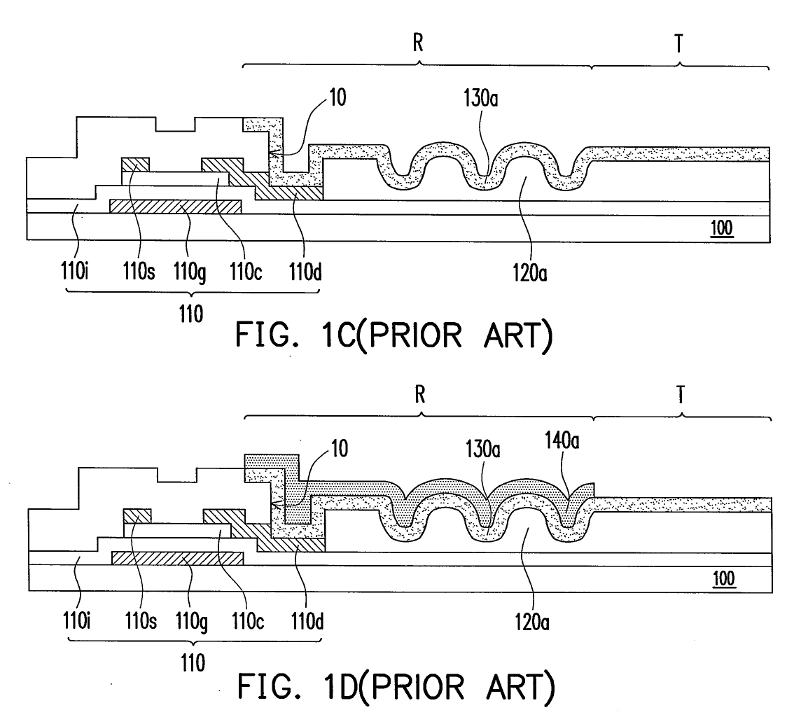

### DESCRIPTION OF EMBODIMENTS

### First Embodiment

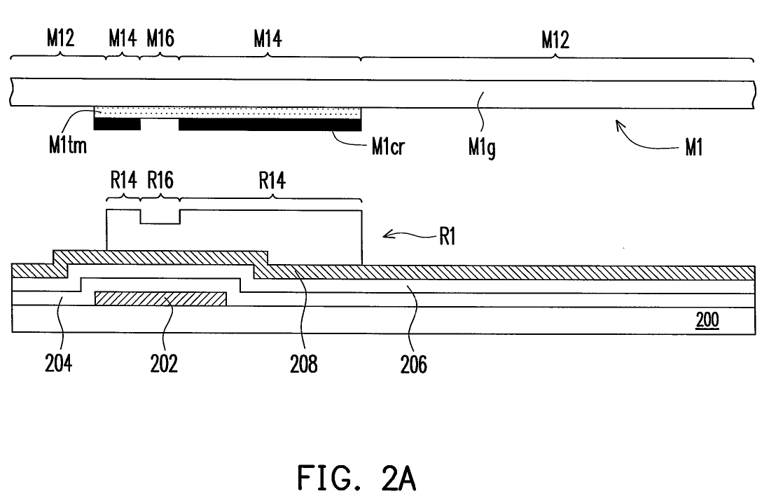

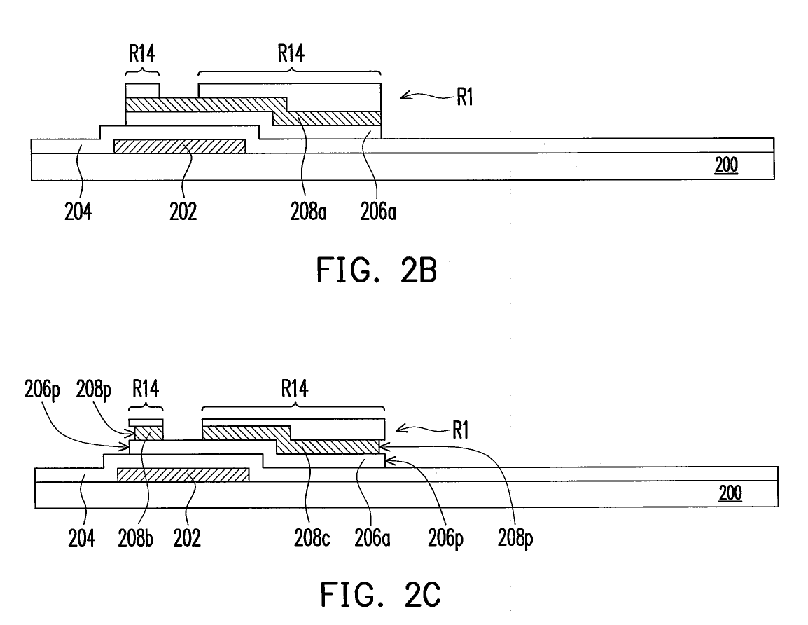

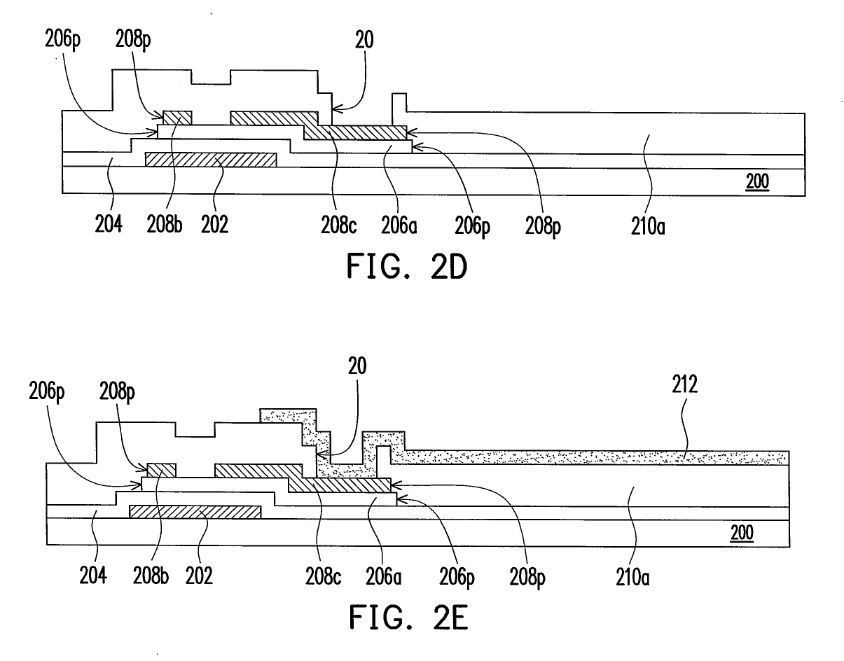

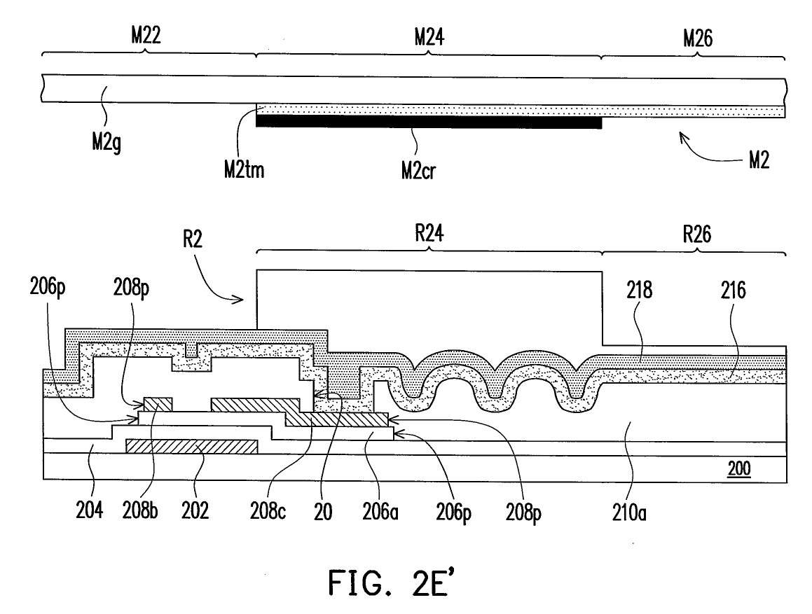

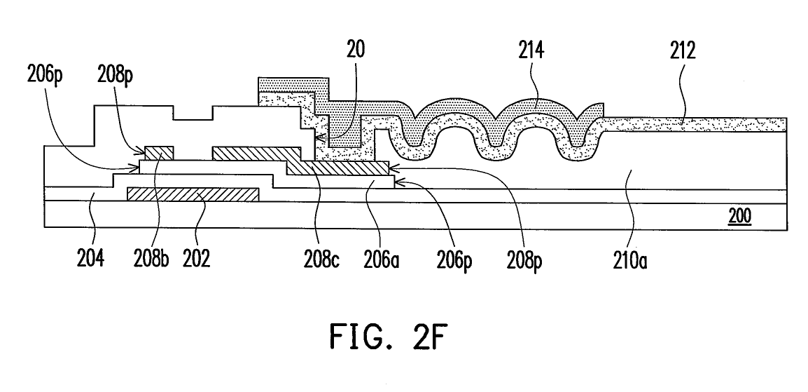

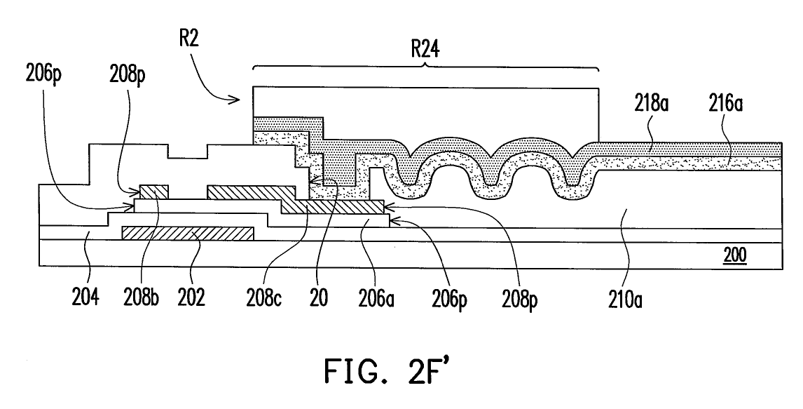

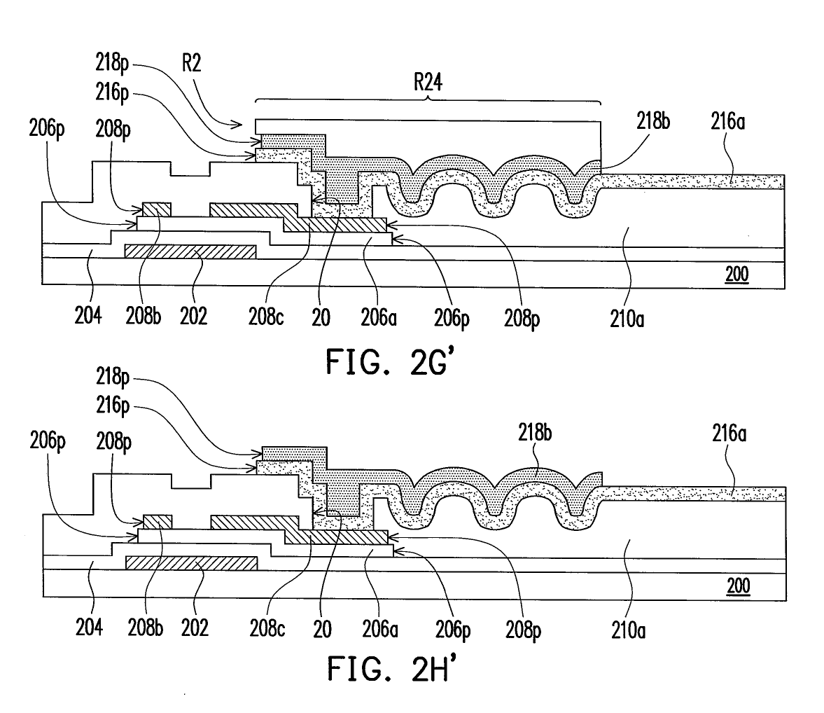

FIGS. 2A˜2E are schematic views illustrating a method of fabricating a pixel structure according to a first embodiment of the present invention. Referring to FIG. 2A, first, a substrate 200 is provided. Next, a gate 202 and a gate insulating layer 204 are sequentially formed over the substrate 200, wherein the gate insulating layer 204 covers the gate 202. Next, a semiconductor layer 206 and a conductor layer 208 are sequentially formed over the substrate 200. Next, a first half tone mask (HTM) M1 is provided, and a first patterned photoresist layer R1 is formed on the conductor layer 208 by using the first HTM M1. The first patterned photoresist layer R1 comprises, for example, a positive photoresist, and the method of forming the first patterned photoresist layer R1 includes, for example, a photolithography process. More particularly, the first HTM M1 includes a glass substrate M1g, a semi-permeable layer M1tm and a chromium layer M1cr, wherein the semi-permeable film M1tm is disposed on the glass substrate M1g and the chromium layer M1cr is disposed on the semi-permeable film M1tm. Therefore, the first HTM M1 may be divided into a transmissive region M12, a non-transmissive region M14 and a semitransmissive region M16. In other words, the first HTM M1 has different optical transmittances in the transmissive region M12, the non-transmissive region M14 and the semitransmissive region M16. For example, the optical transmittances of the transmissive region M12, the non-transmissive region M14 and the semitransmissive region M16 are 90%, 5% and 40% respectively. It should be noted that the mask with different optical transmittance is not limited to the first HTM M1 described above, and the semitransmissive region M16 may also have slits, so as to achieve the object of changing the optical transmittance. Of course, the mask with different optical transmittance is not limited to the above, any other types capable of forming the first patterned photoresist layer R1 can also be applied in this embodiment.

As the transmissive region M12, the non-transmissive region M14 and the semitransmissive region M16 respectively have different optical transmittances, the first patterned photoresist layer R1 is divided into three regions of different thicknesses after the lithography process. More particularly, the first patterned photoresist layer R1 is divided into a photoresist region R14 and a photoresist region R16, wherein the photoresist region R14 represents the form of the non-transmissive region M14, and the photoresist region R16 represents the form of the semitransmissive region M16, and the thickness of the photoresist region R16 is smaller than that of the photoresist region R14. Further, the region on the conductor layer 208 not covered by the first patterned photoresist layer R1 represents the form of the transmissive region M12.

Next, referring to FIG. 2B, portions of the conductor layer 208 and the semiconductor layer 206 are removed by using the first patterned photoresist layer R1 as a mask to form a channel layer 206a and a patterned conductor layer 208a. The method of removing the above-mentioned layers includes, for example, a dry etching process. As the thickness of the first patterned photoresist layer R1 becomes thinner in the process of removing a portion of the conductor layer 208 and the semiconductor layer 206, the photoresist region R16 may also be removed, leaving only the photoresist region R14.

Next, referring to FIG. 2C, a portion of the patterned conductor layer 208a is removed by using the remainder first patterned photoresist layer R1 as a mask, so as to form a source 208b and a drain 208c. The method of removing portion of the patterned conductor layer 208a includes, for example, a dry etching process. Basically, the boundary 208p of the source 208b and the drain 208c must be aligned with the boundary 206p of the channel layer 206a. However, as the boundary of the patterned conductor layer 208a is exposed to the environment of dry etching process, a portion of the boundary of the patterned conductor layer 208a is also etched. More particularly, the boundary 208p of the source 208b and the drain 208c are located within the boundary 206p of the channel layer 206a.

Referring to FIG. 2D, after the above-mentioned structure is formed, the first patterned photoresist layer R1 is removed. The method of removing the first patterned photoresist layer R1 includes, for example, plasma ashing. Next, a patterned passivation layer 210a is formed on the substrate 200. The patterned passivation layer 210a has a contact opening 20, which exposes a portion of the drain 208c.

Referring to FIG. 2E, a transparent pixel electrode 212 is formed on the substrate 200, which is electrically connected to the drain 208c via the contact opening 20. When the process progresses to this step, a pixel structure applicable in the transmissive LCD has been formed on the substrate 200.

### Second Embodiment

FIG. 2F is a schematic view of a method of fabricating a pixel structure according to a second embodiment of the present invention. Referring to FIG. 2F, after the transparent pixel electrode 212 is formed on the structure of FIG. 2E, a reflective pixel electrode 214 is formed over the transparent pixel electrode 212. The pixel structure as shown in FIG. 2F is applicable in the transflective LCD. However, the sequence for forming the reflective pixel electrode 214 and the transparent pixel electrode 212 may be changed. The method of forming the reflective pixel electrode 214 includes, for example, forming a reflective material layer (not shown) on the transparent pixel electrode 212 by sputtering and performing a patterning process to pattern the reflective material layer to form the reflective pixel electrode 214. It should be noted that the reflective pixel electrode 214 and the transparent pixel electrode 212 may be simultaneously formed by using an HTM, which is illustrated in detail below.

### Third Embodiment

FIGS. 2E′ to 2H′ are schematic views illustrating a method of fabricating a pixel structure according to a third embodiment of the present invention. Referring to FIG. 2E′, a first pixel material layer 216 and a second pixel material layer 218 are sequentially formed above the structure as shown in FIG. 2D. Next, a second HTM M2 is provided, and a second patterned photoresist layer R2 is formed on the second pixel material 218 by using the second HTM M2. The second patterned photoresist layer R2 includes, for example, a positive photoresist, and the method of forming the second patterned photoresist layer R2 includes, for example, a photolithography process. More particularly, the second HTM M2 comprises a glass substrate M2g, a semi-permeable layer M2tm and a chromium layer M2cr, wherein the semi-permeable film M2tm is disposed on the glass substrate M2g and the chromium layer M2cr is disposed on the semi-permeable film M2tm. Therefore, the second HTM M2 may be divided into a transmissive region M22, a non-transmissive region M24 and a semitransmissive region M26. In other words, the second HTM M2 has different optical transmittances in the transmissive region M22, the non-transmissive region M24 and the semitransmissive region M26. For example, the optical transmittances of the transmissive region M22, the non-transmissive region M24 and the semitransmissive region M26 are, for example, 90%, 5% and 40% respectively. It should be noted that the mask with different optical transmittance is not limited to the second HTM M2 described above, and the semitransmissive region M26 may also have slits, so as to achieve the object of changing the optical transmittance. Of course, the mask with different optical transmittances is not limited a manner described above, and masks of other types capable of forming the second patterned photoresist layer R2 can also be applied in this embodiment.

As the transmissive region M22, the non-transmissive region M24 and the semitransmissive region M26 respectively have different optical transmittances, the second patterned photoresist layer R2 is divided into three regions of different thicknesses after the photolithography process. More particularly, the second patterned photoresist layer R2 is divided into a photoresist region R24 and a photoresist region R26, wherein, the photoresist region R24 represents the form of the non-transmissive region M24, the photoresist region R26 represents the form of the semitransmissive region M26, and the thickness of the photoresist region R26 is smaller than that of the photoresist region R24. The region on the second pixel material 218 not covered by the second patterned photoresist layer R2 represents the form of the transmissive region M22.

Next, referring to FIG. 2F′, portions of the second pixel material 218 and the first pixel material 216 are removed by using the second patterned photoresist layer R2 as a mask to form a patterned second pixel material 218a and a transparent pixel electrode 216a. The method of removing portions of the second pixel material 218 and the first pixel material 216 includes, for example, a dry etching process. As the thickness of the second patterned photoresist layer R2 also becomes thinner during the process of removing a portion of the second pixel material 218 and the first pixel material 216, the photoresist region R26 is also removed, leaving only the photoresist region R24. The transparent pixel electrode 216a is electrically connected to the drain 208c via the contact opening 20.

Next, referring to FIG. 2G′, a portion of the patterned second pixel material 218a is removed by using the remainder second patterned photoresist layer R2 as a mask to form a reflective pixel electrode 218b. The reflective pixel electrode 218b is, for example, electrically connected to the drain 208c via the contact opening 20. However, the present invention is not limited to this arrangement. For example, the reflective pixel electrode 218b may also be electrically connected to the drain 208c via the transparent pixel electrode 216a. The method of removing the portion of patterned second pixel material 218a includes, for example, a dry etching process. Basically, the boundary 218p of the reflective pixel electrode 218b must be aligned with the boundary 216p of the transparent pixel electrode 216a. However, as the boundary 218p of the patterned second pixel material 218a is exposed to the environment of dry etching process, a portion of the boundary 218p of the patterned second pixel material 218a may be etched away. More particularly, the boundary 218p of the reflective pixel electrode 218b is located within the boundary 216p of the transparent pixel electrode 216a. The reflective pixel electrode 218b is electrically connected to the drain 208c, for example, via the contact opening 20. However, the present invention is not limited to this arrangement. Next, referring to FIG. 2H′, the second patterned photoresist layer R2 is removed using, for example, plasma ashing.

The pixel structures of the first embodiment to the third embodiment using the above-mentioned fabrication method are illustrated below.

First, the pixel structure of the first embodiment is illustrated. This pixel structure is applicable in the transmissive liquid crystal display. Referring to FIG. 2E, the pixel structure of the present invention includes a substrate 200, a gate 202, a gate insulating layer 204, a channel layer 206a, a source 208b, a drain 208c, a patterned passivation layer 210a and a transparent pixel electrode 212. The gate 202 is disposed on the substrate 200, and the gate insulating layer 204 covers the gate 202. The channel layer 206a is disposed on the gate insulating layer 204, and located above the gate 202. The source 208b and the drain 208c are disposed on the channel layer 206a. According to the above-mentioned process, the boundary 208p of the source 208b and the drain 208c is located within the boundary 206p of the channel layer 206a. The patterned passivation layer 210a covers the source 208b, the drain 208c, the channel layer 206a and the gate insulating layer 204. The patterned passivation layer 210a has a contact opening 20. The transparent pixel electrode 212 is disposed on the patterned passivation layer 210a, and electrically connected to the drain 208c through the contact opening 20.

Next, referring to FIG. 2F, the pixel structure of the second embodiment is illustrated. This pixel structure is applicable in the transflective liquid crystal display. In the second embodiment, the pixel structure further includes a reflective pixel electrode 214, disposed on the transparent pixel electrode 212. In FIG. 2F, as the reflective pixel electrode 214 is, for example, fabricated by well known methods, it is not described herein. However, in the embodiment described with reference to FIG. 2H′ above, since the reflective pixel electrode 214 is formed by patterning the second patterned photoresist layer R2, it has a special profile.

Hereinafter, the pixel structure of the third embodiment is illustrated. In the third embodiment, this pixel structure is applicable in the transflective liquid crystal display, referring to FIG. 2H′. This pixel structure is provided with a layer of reflective pixel electrode 218b, which is disposed on the transparent pixel electrode 216a. It should be noted that, the boundary 218p of the reflective pixel electrode 218b is definitely within the boundary 216p of the transparent pixel electrode 216a. Further, the reflective pixel electrode 218b is also, for example, electrically connected to the drain 208c via the contact opening 20, but the present invention is not limited to this.

In the first and second embodiments, the first HTM is used to simultaneously form the channel layer, the source and the drain. In the third embodiment, a second HTM is further used to simultaneously form the reflective pixel electrode and the transparent pixel electrode. Further, the channel layer and the source, and the drain may not be fabricated by the method of the present invention, but the second HTM is still used to simultaneously form the reflective pixel electrode and the transparent pixel electrode. In other words, the process of using the first HTM and the process of using the second HTM may be performed at the same time, or one of them may be chosen. The method may employ only the second HTM and the pixel structure fabricated therefrom may be easily obtained employing the methods described above, and therefore is not described herein.

The present invention uses the first HTM to form the first patterned photoresist layer, and uses the first patterned photoresist layer as a mask to simultaneously form the channel layer, the source, and the drain. Therefore, a mask is saved, and the fabrication cost of the pixel structure is reduced. In addition, a second HTM is used to form the second patterned photoresist layer. Next, the second patterned photoresist layer is used as the mask to form the reflective pixel electrode and the transparent pixel electrode at the same time, thus saving a mask and thereby reduce the fabrication cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a pixel structure, comprising:
providing a substrate;
sequentially forming a gate and a gate insulating layer over the substrate, wherein the gate insulating layer covers the gate;
sequentially forming a semiconductor layer and a conductor layer over the substrate;
providing a first half tone mask (HTM);
forming a first patterned photoresist layer on the conductor layer by using the first HTM;
removing portions of the conductor layer and the semiconductor layer by using the first patterned photoresist layer as a mask to form a source, a drain and a channel layer;
removing the first patterned photoresist layer;
forming a patterned passivation layer over the substrate, wherein the patterned passivation layer has a contact opening for exposing a portion of the drain; and
forming a transparent pixel electrode over the substrate, wherein the transparent pixel electrode is electrically connected to the drain via the contact opening.

2. The method of fabricating a pixel structure as claimed in claim 1, further comprising a step of forming a reflective pixel electrode after the step of forming the transparent pixel electrode.

3. The method of fabricating a pixel structure as claimed in claim 2, wherein the step of forming the transparent pixel electrode and the reflective pixel electrode comprises:
sequentially forming a first pixel material and a second pixel material over the substrate;
providing a second HTM;
forming a second patterned photoresist layer on the second pixel material by using the second HTM;
removing portions of the second pixel material and the first pixel material by using the second patterned photoresist layer as a mask to form the reflective pixel electrode and the transparent pixel electrode; and
removing the second patterned photoresist layer.

4. A method of fabricating a pixel structure, comprising:
providing a substrate;
sequentially forming a gate and a gate insulating layer over the substrate, wherein the gate insulating layer covers the gate;
forming a channel layer on the gate insulating layer and above the gate;
forming a source and a drain on the channel layer;
forming a patterned passivation layer over the substrate, wherein the patterned passivation layer has a contact opening exposing a portion of the drain;
sequentially forming a first pixel material and a second pixel material over the substrate;
providing a HTM;
forming a patterned photoresist layer on the second pixel material by using the HTM;
removing portions of the second pixel material and the first pixel material by using the patterned photoresist layer as a mask to form a reflective pixel electrode and a transparent pixel electrode, wherein the transparent pixel electrode is electrically connected to the drain via the contact opening; and
removing the patterned photoresist layer.

5. A pixel structure comprising:
a substrate;
a gate, disposed on the substrate;
a gate insulating layer, covering the gate;
a channel layer, disposed on the gate insulating layer, and located above the gate;
a source and a drain, disposed on the channel layer, and the boundary of the source and the drain being within the boundary of the channel layer;
a patterned passivation layer, covering the source and the drain, the channel layer and the gate insulating layer; and
a transparent pixel electrode, disposed on the patterned passivation layer, and electrically connected to the drain.

6. The pixel structure as claimed in claim 5, further comprising a reflective pixel electrode disposed on the transparent pixel electrode.

7. The pixel structure as claimed in claim 6, wherein the boundary of the reflective pixel electrode is within the boundary of the transparent pixel electrode.

8. A pixel structure comprising:
a substrate;
a gate, disposed on the substrate;
a gate insulating layer, covering the gate;
a channel layer, disposed on the gate insulating layer, and located above the gate;
a source and a drain, disposed on the channel layer and the gate insulating layer;
a patterned passivation layer, covering the source and the drain, the channel layer and the gate insulating layer;
a transparent pixel electrode, disposed on the patterned passivation layer, and electrically connected to the drain; and
a reflective pixel electrode, disposed on the transparent pixel electrode, and the boundary of the reflective pixel electrode being within the boundary of the transparent pixel electrode.
